(19) United States
(12) Patent Application Publication
(10) Pub. No.: US 2012/0066960 A1
(43) Pub. Date: Mar. 22, 2012

(54) Bait Station

(76) Inventor: Alan E. Pryor, Hartford, WI (US)

(21) Appl. No.: 12/887,999

(22) Filed: Sep. 22, 2010

(51) Int. Cl. A01M 1/20; B23P 11/02

(52) U.S. Cl. 43/131; 29/453; 29/464

(57) ABSTRACT

A bait station for use in terminating pests is provided. The bait station preferably includes a top member and a bottom member. The bottom member includes a bait reservoir to be filled with bait. Upon filling, the bottom member and the top member are coupled together by interaction of connecting portions of each to irremovably attach the top member to the bottom member. The connection between the top member and bottom member is preferably childproof.

### BACKGROUND OF THE INVENTION

1. Field of the Invention

The present invention relates generally to bait stations, and more particularly to an ant and roach bait station.

Pests such as ants and roaches and infestations of the same are typically undesirable for consumers. Consumers tend to deal with such undesirable pests by placing bait tending to attract these pests throughout areas of homes. The pests find and ingest the bait or carry it back to their nesting places. The bait contains an active ingredient designed to exterminate the pests, either immediately or over time.

In the past, bait could be purchased by consumers in pre-loaded bait stations. Typically, such bait stations are formed from multiple components, are difficult for the manufacturer to assemble, and are difficult for the manufacturer to fill. This is undesirable, since these qualities add to the time and cost to produce such bait stations. Additionally, such conventional bait stations are easily disassembled after having been placed by a consumer. This is undesirable since a child may disassemble a bait station and access the bait inside. Contact with or ingestion of the active ingredient in the bait is dangerous to the child and may make the child quite ill. Additionally, in such conventional bait stations, it is difficult to determine when the bait station is empty. This is undesirable, since pests in locations where empty bait stations are located will not be controlled.

Therefore, it may be appreciated that it would be desirable to provide a bait station that would reduce the cost associated with the difficulty of assembling and filling a bait station. It would also be desirable to reduce the cost to manufacture a bait station by reducing the complexity and number of components therein. It would also be desirable to provide a bait station that is not easily disassembled, such that it is childproof to prevent small children from accessing the bait contained within the bait station. It would also be desirable to provide a bait station that allow users to easily determine whether and how much bait is disposed therein.

The bait station of the present invention must also be of construction which is both durable and long lasting, and it should also require little or no maintenance to be provided by the user throughout its operating lifetime. In order to enhance the market appeal of the bait station kit of the present invention, it should also be of inexpensive construction to thereby afford it the broadest possible market. Finally, it is also an objective of the present bait station kit that all of the aforesaid advantages and objectives be achieved without incurring any substantial relative disadvantage.

### SUMMARY OF THE INVENTION

The disadvantages and limitations of the background art discussed above are overcome by the present invention. With this invention, a bait station including a bottom member defining a bait reservoir and at least one axial projection is provided. The axial projection defines at least one locating notch and an attachment portion. A top member including at least one locating portion configured to interface with the at least one locating notch is also provided. The top member also includes an attachment projection configured to interface with the attachment portion of the bottom member. Once the attachment projection and the attachment portion are coupled, the connection is configured to be childproof.

In another aspect, the present invention provides a bait station including a bottom member including a bait reservoir containing a sufficient amount of bait, the bait reservoir being at least partially defined by a wall. The bait station also includes a top member and at least one access port defined by portions of the bottom member and the top member, configured to allow a pest access to the bait reservoir. The wall includes at least one projection, the at least one projection defining an apparatus to index the top member relative to the bottom member. The bait station is configured to prevent a child from gaining access to the bait.

In another aspect, the present invention teaches a method of making a bait station including the steps of providing a bottom member including a bait reservoir, providing a top member configured to couple to the bottom member, filling the bait reservoir with bait, using an indexing feature of at least one of the bottom member and the top member to orient the top member and bottom member relative to one another, and irremovably coupling the top member to the bottom member without the use of adhesives, welding, or tools.

The bait station of the present invention is of a construction which is both durable and long lasting, and which will require little or no maintenance to be provided by the user throughout its operating lifetime. The bait station of the present invention is also of inexpensive construction to enhance its market appeal and to thereby afford it the broadest possible market. Finally, all of the aforesaid advantages of the bait station of the present invention are achieved without incurring any substantial relative disadvantage.

### DESCRIPTION OF THE DRAWINGS

These and other advantages of the present invention are best understood with reference to the drawings, in which:

FIG. 1 shows an isometric exploded view of an embodiment of a bait station in accordance with the teachings of the present invention;

FIG. 2 shows an isometric view from below the bait station of FIG. 1;

FIG. 3 shows an isometric view from above the bait station of FIGS. 1 and 2;

FIG. 4 shows an isometric view from below of the top member of the bait station of FIGS. 1-3;

FIG. 5 shows a top plan view of the bait station of FIGS. 1-4;

FIG. 6 shows a cross-sectional exploded view along the line 6-6 of FIG. 5; and

FIG. 7 shows a cross-sectional assembled view along the line 7-7 of FIG. 5.

### DETAILED DESCRIPTION OF THE EXEMPLARY EMBODIMENTS

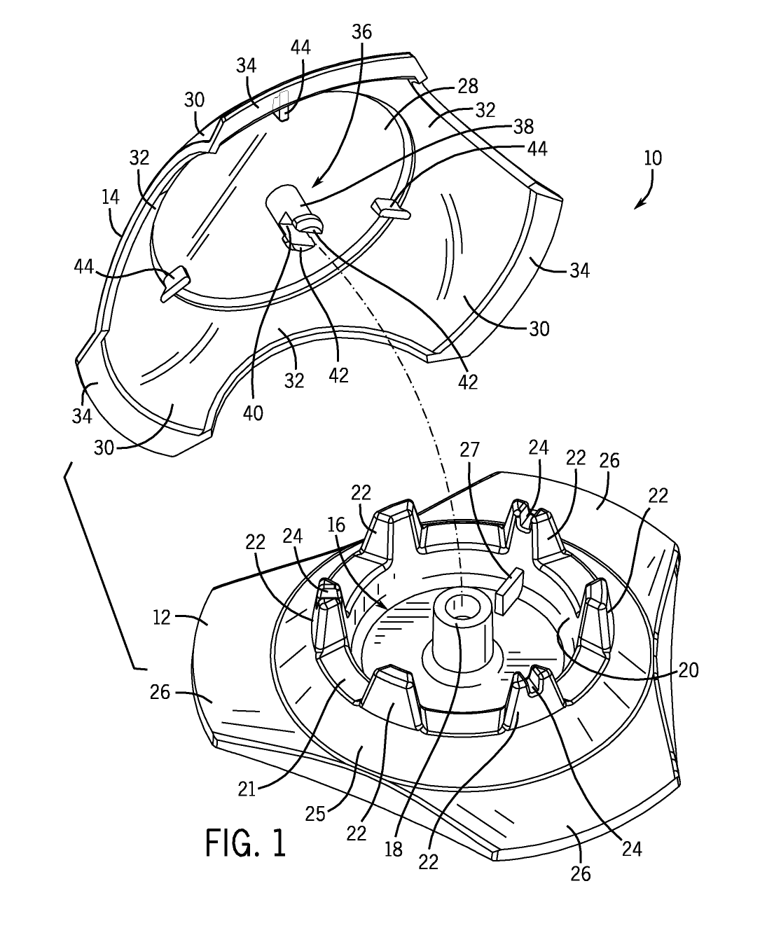

Referring initially to FIG. 1, an exemplary embodiment of a bait station 10 in accordance with the teachings of the present invention is illustrated. Pests to be targeted may include ants and roaches, as well as other insects and vermin. The bait station 10 is configured to be placed on various surfaces. The bait station 10 includes a bottom member 12 coupled to a top member 14.

The bottom member 12 of the bait station 10 defines therein an annular bait reservoir 16. An attachment cylinder 18 is formed preferably at the center of the bait reservoir 16 and extends axially upwardly therefrom. As will be described further below, the attachment cylinder 18 is configured for use in coupling the bottom member 12 to the top member 14. The periphery of the bait reservoir 16 is defined by an axially upwardly extending cylindrical wall 20. The axially extending wall 20 is sufficiently high to contain an effective amount of bait within the bait reservoir 16.

In one embodiment, integrally formed with and axially extending upwardly from an annular flat top surface 21 extending outwardly from the top of the wall 20 are a plurality of upwardly extending projections 22. The projections 22 may be evenly arranged around the periphery of the bait reservoir 16 and extend axially upwardly proximate to or in contact with the underside of the top member 14 when the bait station 10 is in an assembled configuration. In the illustrated embodiment, the bottom member 12 includes six projections 22 arranged circumferentially equidistant on the annular flat top surface 21 around the periphery of the wall 20.

In one embodiment, defined in the portion of at least one, and preferably a plurality, of the projections 22 at the end most distal from the bait reservoir 16 is a locating notch 24. In the illustrated embodiment, three of the six projections (every other projection 22) define locating notches 24. In this embodiment, each of the projections 22 defining a locating notch 24 is located between two projections 22 that do not define a locating notch 24.

In one embodiment, annular flat top surface transitions obliquely downwardly into a frustroconical transition portion 25. Projecting radially outwardly from this frustroconical transition portion 25 are three radially projecting leg members 26. These leg portions 26 provide added stability when the bait station 10 is placed onto a flat surface. The leg portions 26 and the frustroconical transition portion 25 may, together with the top member 14, define entryways for ants, roaches, pests, and vermin as will be further described below.

In one embodiment, the bait reservoir 16 may include a fill indicator 27 projecting radially upwardly from the bottom of the bait reservoir 16 and coupled to the wall 20. The fill indicator 27 may be integrally molded with the bottom member 12, or it may be molded separately therefrom and attached thereto. The fill indicator 27 may serve to indicate when a proper amount of bait is deposited in the bait reservoir 16 and may also indicate to a user the amount of bait remaining in the bait reservoir 16, as well indicating when the bait reservoir 16 no longer contains sufficient bait. In FIG. 3, for example, sufficient bait is deposited within the bait reservoir 16 so that the fill indicator 7 is no longer visible.

In one embodiment, the bottom member 12 is formed of a single plastic segment. The bottom member 12 may be formed from any suitable plastic known in the art. It is also envisioned that other suitable materials may instead be used to form the bottom member 12. Alternatively, the bottom member 12 may be formed in separate segments that are coupled together by any method known in the art.

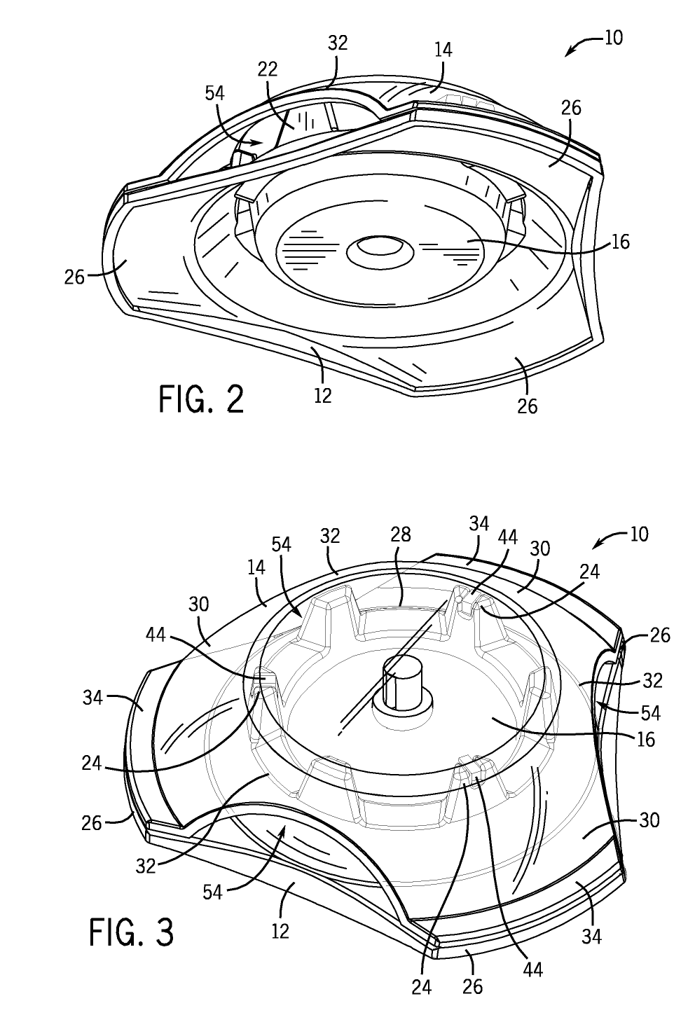

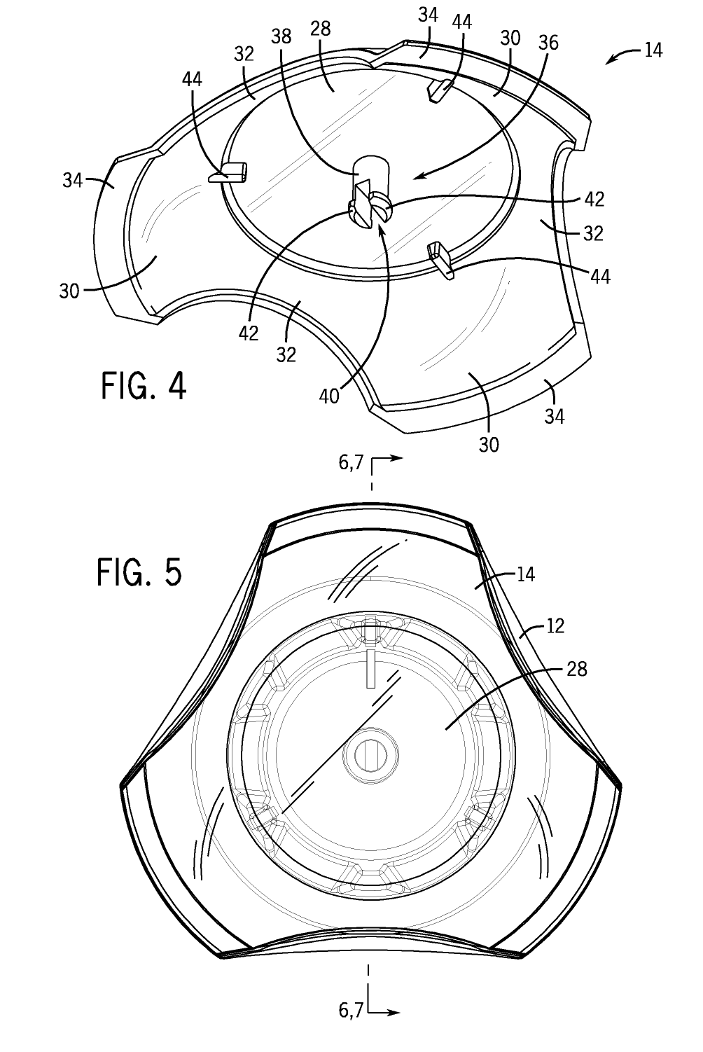

Again with reference to FIGS. 1-4, the top member 14 is may also be formed of a single molded plastic segment made of any suitable material known in the art. It is also contemplated that other suitable materials may instead be used to form the top member 14 are. In a preferred embodiment, the top member 14 is transparent or translucent so that the amount of bait contained in the bait reservoir 16 may be observed without removing the top member 14 from the bottom member 12. Alternatively, the top member 14 may be formed in separate segments that are coupled together by any method known in the art.

In one embodiment, the top member 14 includes a flat disc-like segment 28. Projecting arcuately radially outwardly and downwardly from the disc-like segment 28 are three arcuate portions 30 connected by three axially narrower connection portions 32. Coupled to the portion of the arcuate portions 30 distal from the disc-like segment 28 are outwardly-extending flanges 34 configured to interface with the leg portions 26 of the bottom member 12 when the bait station 10 is in an assembled configuration, as will be more fully explained below.

The underside of the disc-like segment 28 defines at its center in one embodiment an expansion plug 36 extending axially downwardly from the center of the disc-like segment 28. The expansion plug 36 includes a base cylinder 38 coupled at one end to the disc-like segment 28. The free end of the base cylinder 38 has an expansion groove 40 cut into its downwardly-extending distal end, with the two halves of the base cylinder each having a radially outwardly-extending expansion tooth 42. As will be more fully explained below, these components of the expansion plug 36 are configured to couple with the attachment cylinder 18 to join the top member 14 to the bottom member 12.

The underside of the disc-like segment 28 additionally defines near its outer periphery a plurality of downwardly-extending locating projections 44. The locating projections 44 are oriented radially outwardly and extend to and are couples with the arcuate portions 30. In one embodiment, the number of locating projections 44 is equal to the number of locating notches 24 defined in the projections 22 of the bottom member 12. The locating projections 44 in the top member 14 are configured to interact with the locating notches 24 of the bottom member 12 to properly orient the top member 14 with respect to the bottom member 12. If the locating projections 44 are positioned over projections 22 without locating notches 24, the expansion plug 36 will not properly engage the attachment cylinder 18. Thus, the locating projections 44 serve an indexing and orientation function.

As may best be seen in FIGS. 1, 5, and 6, once the bait reservoir 16 has been filled with bait, the bottom member 12 and the top member 14 may be joined by aligning the expansion plug 36 in the top member 14 with the attachment cylinder 18 in the bottom member 12, and aligning the locating projections 44 in the top member 14 with the locating notches 24 in the bottom member 12. The top member 14 and the bottom member 12 may then be urged together. When the expansion teeth 42 contact the attachment cylinder 18, the expansion teeth 42 tend to deflect inwardly towards one another, reducing the size of the expansion groove 40. This allows the expansion plug 36 to fit within the attachment cylinder 18.

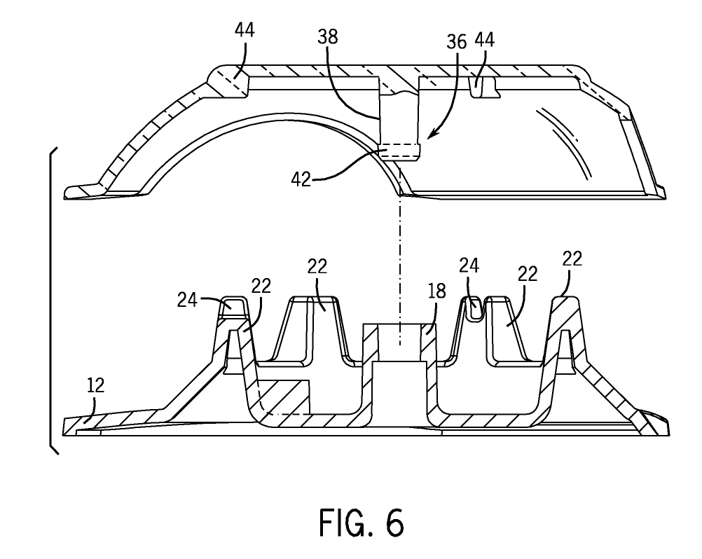

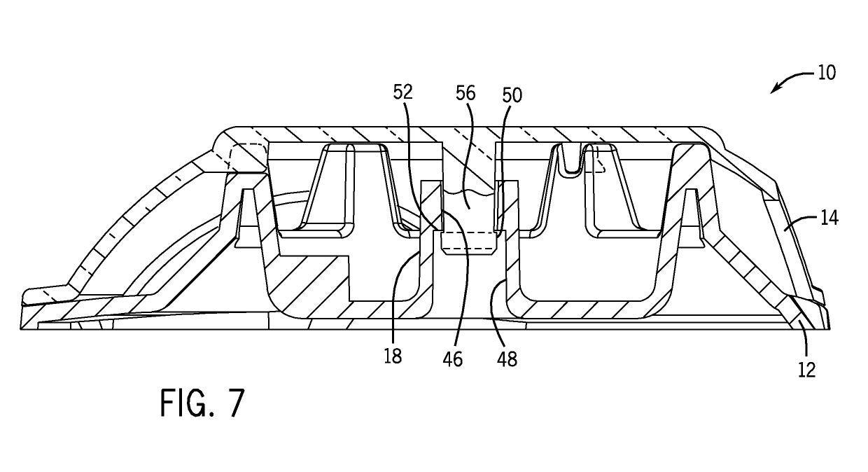

The attachment cylinder 18 includes a smaller diameter portion 46 at its upper end and a larger diameter portion 48 axially below the smaller diameter portion 46 (as best shown in FIGS. 6 and 7), with an annular flange 52 being located at the intersection of the larger diameter portion 48 and the smaller diameter portion 46. The compressed expansion teeth 42 travel down the smaller diameter portion 46 until reaching the larger diameter portion 48, upon which the expansion teeth 42 will expand outwardly to their original configuration, restoring the expansion groove 40 to its original size.

Thus, if a user attempts to remove the top member 14 from the bottom member 12, the upper portion of the expansion teeth 42 will encounter the annular flange 52 at the bottom of the smaller diameter portion 46, thereby preventing the expansion plug 36 from being withdrawn from the attachment cylinder 18 and retaining the top member 14 fixedly attached to the bottom member 12. The illustrated embodiment of the bait station 10 thus provides a secure, childproof attachment between the bottom member 12 and top member 14.

Other configurations of both the attachment cylinder 18 and the expansion plug 36 are also contemplated, including an interference fit between the two parts, adhesive, thermal welding, and any other suitable connection mechanism between the top member 14 and bottom member 12 known in the art.

As may be seen in FIGS. 1 and 3, when the top member 14 is joined to the bottom member 12, the locating projections 44 interface with the locating notches 24 in such a manner as to prevent rotation of the top member 14 relative to the bottom member 12.

When the top member 14 and bottom member 12 are coupled together, the areas between the three axially narrower connection portions 32 (which are located intermediate the three arcuate portions 30 in the top member 14) and the areas intermediate the leg portions 26 of the bottom member 12 together define access ports 54. In the illustrated embodiment, three such access ports 54 are defined, each configured to allow ants, roaches, pests, and/or other vermin access to bait contained within the bait reservoir 16 inside the bait station 10.

In the illustrated embodiments, the bait stations 10 may be placed in location(s) accessible by pests. When pests access the bait disposed within the bait stations 10 and eat the bait, they will be exterminated by the active ingredient included in the bait.

The bait is preferably a fluid or a gel, and preferably includes both an active ingredient and an inactive ingredient. If the pests to be targeted are ants, the bait may, for example, be a gel marketed by the DuPont corporation under the trademark ADVION™ ADVION™ includes the active ingredient INDOXACARB (S-Enantiomer) in a concentration of between approximately 0.02% and 0.06% by mass, and preferably 0.03% by mass. However, other suitable baits may be used for targeting ants. If the pests to be targeted are roaches, the bait may, for example, be ADVION™ containing INDOXACARB (S-Enantiomer) in a concentration of between approximately 0.20% and 0.60% by mass, and preferably approximately 0.30% by mass.

If the pests to be targeted are other vermin, other suitable baits may be used.

Each bait station 10 in one embodiment has a capacity of between approximately 1 and 5 grams of bait, and more preferably a capacity of approximately 2 grams.

For purposes of this disclosure, the term “coupled” means the mechanical joining of two components directly or indirectly to one another. Such joining may be stationary in nature or moveable in nature. Such joining may be achieved with the two components and any additional intermediate members being integrally formed as a single unitary body with one another or the two components and any additional member being attached to one another. Such joining may be permanent in nature or alternatively be removable or releasable in nature.

Although the foregoing description of the bait station of the present invention has been shown and described with reference to particular embodiments and applications thereof, it has been presented for purposes of illustration and description and is not intended to be exhaustive or to limit the invention to the particular embodiments and applications disclosed. It will be apparent to those having ordinary skill in the art that a number of changes, modifications, variations, or alterations to the invention as described herein may be made, none of which depart from the spirit or scope of the present invention. The particular embodiments and applications were chosen and described to provide the best illustration of the principles of the invention and its practical application to thereby enable one of ordinary skill in the art to utilize the invention in various embodiments and with various modifications as are suited to the particular use contemplated. All such changes, modifications, variations, and alterations should therefore be seen as being within the scope of the present invention as determined by the appended claims when interpreted in accordance with the breadth to which they are fairly, legally, and equitably entitled.

What is claimed is:

1. A bait station comprising:
a bottom member comprising:
a bait reservoir located in the bottom member;
a plurality of projections dispersed around and extending upwardly above the bait reservoir;
at least one locating notch located in at least one of the plurality of projections at an end distal from the bait reservoir; and
a first attachment member located in the bait reservoir and extending upwardly therefrom; and
a top member comprising:
a supported segment that will be supported by the plurality of projections extending upwardly above the bait reservoir in the bottom member;
a second attachment member extending downwardly from the supported segment for engagement with the first attachment member located in the bait reservoir in the bottom member to retain the top member on the bottom member;
at least one locating member disposed under the supported segment of the top member and configured to interface with the at least one locating notch to orient the top member with respect to the bottom member;
wherein the top member and the bottom member when attached define at least one externally accessible opening that is configured to be accessible by a pest; and
wherein once the first attachment member and the second attachment member are coupled, the connection is configured to be childproof.

2. The bait station of claim 1, wherein the first attachment member comprises an attachment cylinder configured to receive the second attachment member of the top member.

3. The bait station of claim 2, wherein the attachment cylinder comprises a smaller diameter segment and a larger diameter portion located below the smaller diameter segment;
wherein at least a portion of the second attachment member is configured to compress within the smaller diameter segment and expand within the larger diameter segment; and
wherein, upon expanding, the expanded portion of the second attachment member is trapped within the larger diameter segment of the first attachment member, thereby coupling the top member to the bottom member.

4. The bait station of claim 1, wherein the top member is one of transparent and translucent.

5. The bait station of claim 1, wherein the bait reservoir comprises an annular bait reservoir, and wherein the center of the annular bait reservoir is defined by the first attachment member.

6. The bait station of claim 1, additionally comprising bait disposed within the bait reservoir, wherein said bait comprises a gel.

7. The bait station of claim 1, wherein alternate ones of the projections in the bottom member have locating notches therein; and
wherein the locating members in the top member each correspond to one of the locating notches in the bottom member; and
wherein the locating members and the locating notches are configured to interact with each other to prevent rotation of the top member relative to the bottom member.

8. The bait station of claim 1, wherein second attachment member in the top member and the first attachment member in the bottom member are configured to be permanently attached to each other without the use of adhesive, heat-staking, or tools.

9. A bait station comprising:
a bottom member comprising a bait reservoir containing an amount of bait and a first attachment member, the bait reservoir being at least partially defined by a wall;
a top member comprising a second attachment member configured to irremovably couple to the first attachment member in the bottom member to irremovably attach the top member to the bottom member, wherein at least one access port is defined between segments of the top member and the bottom member and is configured to allow pests to access the bait reservoir; and
a plurality of indexing members respectively located in the top member and the bottom member to index position of the top member relative to the position of the bottom member when the top member is attached to the bottom member;
wherein the bait station is arranged and configured to prevent a child from gaining access to the bait.

10. The bait station of claim 9, wherein the top member is one of transparent and translucent.

11. The bait station of claim 9, wherein the bottom member defines a plurality of projections dispersed around and extending upwardly above the bait reservoir, and wherein at least one of the plurality of the projections of the bottom member defines a locating notch therein, and wherein the top member defines at least one locating member disposed under the top member that is configured to interact with the locating notch to properly orient the top member and the bottom member with respect to each another.

12. The bait station of claim 9, wherein the first attachment member comprises an attachment cylinder defined in the bait reservoir which extends upwardly from the bottom member toward the top member; and
the second attachment member comprises an expansion plug projecting axially downwardly from the top member towards the bottom member;
wherein the expansion plug is configured to interact with the attachment cylinder to permanently couple the top member to the bottom member.

13. The bait station of claim 12, wherein the attachment cylinder comprises a smaller diameter portion and a larger diameter portion and wherein the expansion plug is configured to compress to allow it to pass through the smaller diameter portion of the attachment cylinder and to expand upon entering the larger diameter portion of the attachment cylinder to thereby prevent the expansion plug from being withdrawn through the smaller diameter portion of the attachment cylinder.

14. A method of making a bait station comprising the steps of:
providing a bottom member including a bait reservoir and a first attachment member;
filling the bait reservoir with bait;
providing a top member including a second attachment member configured to couple to the first attachment member in the bottom member;
using an indexing element contained in at least one of the top member and the bottom member to orient the top member and bottom member relative to one another; and
irremovably coupling the second attachment member in the top member to the first attachment member in the bottom member without the use of adhesives, welding, or tools.

15. The method of claim 14, wherein the top member is transparent.

16. The method of claim 14 wherein the first attachment member comprises an attachment cylinder located in the bait reservoir and extending upwardly therefrom, the attachment cylinder being configured to receive the second attachment member of the top member; and
wherein the second attachment member comprises an expansion plug projecting downwardly from the top member; and
coupling the expansion plug and the attachment cylinder together.

17. The method of claim 16 wherein the expansion plug comprises a pair of teeth separated by a groove; and
wherein the attachment cylinder includes a smaller diameter portion located above a larger diameter portion;
wherein the pair of teeth of the expansion plug are compressed radially inwardly to allow the expansion plug to enter the smaller diameter portion of the attachment cylinder; and
wherein the pair of teeth of the expansion plug expand radially outwardly upon reaching the larger diameter portion of the attachment cylinder thereby locking the teeth within the larger diameter portion of the attachment cylinder.
